(19) United States
(12) Patent Application Publication
(10) Pub. No.: US 2022/0371139 A1
(43) Pub. Date: Nov. 24, 2022

(54) POWER TOOL HAVING AIR COOLING AND METHOD FOR PROTECTING A USER OF A POWER TOOL FROM DUST

(71) Applicant: Hilti Aktiengesellschaft, Schaan (LI)

(72) Inventor: Christian SATTLER, Biessenhofen (DE)

(21) Appl. No.: 17/790,781

(22) PCT Filed: Dec. 14, 2020
(86) PCT No.: PCT/EP2020/085914

§ 371 Date: Jul. 5, 2022

(30) Foreign Application Priority Data
Jan. 10, 2020 (EP) 20151098.9

(51) Int. Cl. B23Q 11/00; B23Q 11/12

(52) U.S. Cl. CPC B23Q 11/005; B23Q 11/127; B25F 5/008

(57) ABSTRACT

A power tool having air cooling for the components of the power tool. Here, the power tool includes exhaust openings for discharging the consumed air to the environment of the power tool. A method for protecting a user of a power tool from dust is also provided. The invention is associated with the essential advantage that air flows that exist as a result of the air cooling inside the power tool are exploited in order to blow the dust that accrues during operation of the power tool in a spatial direction “away from the user”. In a particularly preferred configuration, the air blown out can form an air curtain as a dust shield, which protects the user effectively from dust in that the air curtain keeps the dust away from the user and their airways.

The present invention relates to a power tool having air cooling for the components of the power tool. Here, the power tool comprises exhaust openings for discharging the consumed air to the environment of the power tool. In a second aspect, the invention relates to a method for protecting a user of a power tool from dust.

### BACKGROUND

As is known, undesired dust formation frequently occurs when abrasive substrates are machined with power tools. This can be the case for example when use is made of angle grinders or slot cutters with which for example the substrate “concrete” is machined. In particular, the dust is created during the cutting or grinding processes carried out with the power tool. In many cases, this dust can be hazardous to health. In particular, the dust that arises when working with the power tool should not be breathed in and also should not get into the operator's airways. In order to avoid this, various measures and devices are known from the prior art for preventing the user of the power tool from breathing in the dust. Known, for example, are what are referred to as dust hoods, which can be arranged around the tool of the power tool and are designed to collect or pick up the dust that accrues during operation of the power tool. The tool of the power tool can be for example a cutting or cut-off disk of an angle grinder or slot cutter. Conventional dust hoods, as are known from the prior art, serve to avoid the propagation of dust in conjunction with working with a power tool, in order to protect the health of a user of the power tool from the dust and the possible negative health effects thereof. However, it has been shown that the known measures for dust binding or dust extraction frequently require additional components or accessories on the power tool, this not being accepted by many users or making it much harder to handle the power tool. Frequently, dust hoods or the like have a large volume or the use thereof causes the power tool to be cumbersome.

Conventional dust hoods are also frequently used in conjunction with a vacuum cleaner, in order to extract the dust from the region of the power tool. However, for space and/or supply reasons, vacuum cleaners cannot be used everywhere on every construction site.

### SUMMARY OF THE INVENTION

It is an object of the present invention to overcome the above-described drawbacks and deficiencies of conventional dust protection devices and to provide a power tool in which contact of the user with the dust that arises when working with the power tool is reliably avoided or considerably reduced from the outset. Furthermore, a method for protecting the user from dust is intended to be provided. In the context of the invention, it would be desirable for the technical teaching to be provided not to result in the need to fasten additional components to the power tool, said additional components making the power tool bulkier and more cumbersome and as a result making it harder to work with the power tool. In particular, it would be desirable for it to be necessary to modify the construction of known power tools as little as possible in order to be able to nevertheless provide effective dust protection for the user of the power tool.

The invention provides a power tool having air cooling for the components of the power tool, wherein the power tool comprises exhaust openings for discharging the consumed air to the environment of the power tool. The power tool is characterized in that the exhaust openings are configured such that dust that arises during operation of the power tool is blown away from a user of the power tool. A particular advantage of the invention is that air flows that exist within the power tool with the proposed power tool can be exploited in order to blow the dust away from the user. The air flows within the power tool are preferably brought about by the air cooling that is used to cool the components and constituent parts of the power tool and to protect them from undesired overheating. In other words, in the context of the present invention, air flows that are present and are guided through the power tool on account of the air cooling of the components are used in order to bring about an additional technical effect, namely the blowing away of the dust that arises during operation of the power tool.

Within the meaning of the invention, the term “consumed air” stands preferably for the air that has been guided through the power tool by the air cooling and, after passing through the device, is blown out of the power tool at the exhaust openings. As a result, the consumed air is discharged into the environment of the power tool. As a result of being used as cooling air, it is warmer than the other ambient air. At other points, the power tool can have intake openings at which fresh, unconsumed air is drawn in from the environment in order to be guided as cooling air through the power tool. Provision can be made that, in the context of the present invention, an additional air flow is created, wherein, for this purpose, preferably the air flow present or required for cooling can be used.

The invention can be implemented in particular when the power tool is used outdoors. In such applications, it is frequently sufficient for the user to be protected from dust in that the dust is blown away from them from the outset and as a result the user and their airways do not or substantially do not come into contact with the dust. Tests have shown that a flow rate and/or a volumetric flow of the air curtain can allow an optimal protective effect for the user. In particular, the flow rate and/or the volumetric flow of the air flow can be set by the arrangement or positioning of the exhaust openings. Furthermore, the flow rate and/or the volumetric flow within the air flow can be influenced by the configuration of the exhaust openings, for example as regards the shape thereof.

According to the invention, it is preferred that the size or strength of the created air flow is determined depending on the cooling air flow of the motor, on the volumetric flow of a vacuuming device and/or on the circumferential speed of the cut-off disk of the power tool. Preferably, the flow rate is selected, in the context of the present invention, such that the flow rate is greater than the speed of the dust particles at a point X. This means, for example in the case of an angle grinder, that a flow rate is in a range from 5 to 200 m/s, preferably in a range from 5 to 50 m/s, particularly preferably in a range from 5 to 20 m/s and most preferably greater than 10 m/s. According to the invention, it is particularly preferred that the flow rate can be selected depending on a distance of the point X from a disk circumference and/or a surface of the material being machined. The volumetric flow of the air flow is preferably in a range greater than 20 l/s. Particularly preferably, the volumetric flow of the cooling air flow is in a range greater than 30 l/s. Tests have shown that these values are particularly suitable for forming an effective air curtain and protecting the user of the power tool effectively from dust.

The direction in which the air is blown out of the exhaust openings can also be set, in the context of the present invention, such that substantially all of the dust is blown away from the user. As a result, it is advantageously possible for dust formation and/or a flow of the dust in the direction of the user's head to occur at most very little or not to occur at all. Tests have shown that the invention is affected surprisingly little by wind. According to the invention, it is particularly preferred for the user to adapt their work with the power tool to a current wind direction, with the result that the blowing-away effect of the invention can be enhanced further. According to the invention, it is preferred that the exhaust openings can be varied in terms of their position, design and/or direction, in order to blow the dust that arises during operation of the power tool away from the user of the power tool. In other words, according to the invention, it is preferred that, as a result of a position, design and/or direction of the exhaust openings of the air-cooled power tool, the dust that has arisen during use is blown away from the user.

According to the invention, it may be particularly preferred that the consumed air discharged through the exhaust openings forms an air curtain for protecting the user from dust. A preferred configuration of such an air curtain is illustrated in FIG. 1 (see dotted line). According to the invention, it is preferred that, with the flow of consumed air that is discharged through the exhaust openings of the power tool, an air curtain can be formed, which preferably shields a rear region of the power tool and the user, who is located in this rear region of the power tool when operating the power tool, from the dust that arises during operation of the power tool. It is apparent from FIG. 1 how a dust cloud forms in the front region of the power tool, which advantageously cannot pass or substantially cannot pass into the region of the user's head in the rear region of the power tool on account of the shielding by the air curtain. As a result, the user can be protected effectively from the dust and the undesired breathing in thereof. The user can advantageously move around freely in the rear region of the power tool, since preferably the entire rear region of the power tool is shielded by the air curtain and protected from dust exposure. Tests have shown that the created air curtain behaves in a surprisingly stable manner with respect to the effect of external disturbances. For example, the action of the air curtain remains even in the event of light winds. According to the invention, it may also be preferred that the exhaust openings can be varied in terms of their position, design and/or direction, in order to form, from the consumed air of the air cooling, an air curtain for protecting the user from dust. As a result, it is possible to influence or set for example the shape or the plane in which the air curtain forms.

The air curtain is formed preferably by an air flow that is created by the air cooling in conjunction with the exhaust openings of the power tool. The air cooling comprises preferably a pump that creates the air flow within the power tool, wherein the components of the power tool are cooled by the air flow. According to the invention, the term “air” denotes a gas mixture, which, in particular, includes nitrogen N2 and oxygen O2 as well as various further gases and gas mixtures. Preferably, the air is drawn in from the environment of the power tool by the pump of the air cooling of the power tool and is guided through the device. The consumed air is discharged back into the environment through the exhaust openings. Preferably, the exhaust openings can be configured in a hole-like or nozzle-like manner. A particular advantage of the invention is that the air flow can be fashioned by the exhaust openings and the configuration thereof such that the dust that arises when working with the power tool can be blown away from the user particularly effectively, or such that a particularly strong and robust air curtain for protecting the user from dust can be formed.

Exhaust openings that are formed in particular in a nozzle-like manner allow an increase in the flow rate in the air flow or, if necessary, also a deflection of or a change in the direction of flow of the air flow. According to the invention, it is preferred that the exhaust openings can be formed in a nozzle-like manner, wherein the air curtain or the air flow can advantageously be fashioned in a suitable manner by the nozzle in order to ensure particularly effective dust protection for the user. When the exhaust openings are formed in a nozzle-like manner, the nozzles can for example also be formed in a movable manner. The user can then adapt the air curtain or the blowing-out direction to their requirements or in accordance with the specific application and the spatial conditions thereof.

In a particularly preferred embodiment of the invention, the power tool can have adjusting means with which the flow rate and/or the volumetric flow of the air flow with which the dust is blown away from the user or with which the air curtain is created can be set.

In a second aspect, the invention relates to a method for protecting a user of a power tool from dust. The method is characterized by the following steps:
a) providing a power tool, wherein the power tool comprises air cooling,
b) operating the power tool, wherein dust is created by the operation,
c) operating the air cooling of the power tool, with the result that an air flow is created within the power tool,
d) blowing the air consumed by the air cooling through exhaust openings such that the dust that arises during operation of the power tool is blown away from a user of the power tool.

The terms, definitions and technical advantages introduced for the proposed power tool apply preferably in an analogous manner to the proposed protection method. According to the invention, it is preferred that a power tool is provided that has an air cooling device (“air cooling”). The air cooling can have a pump with which air is drawn in from the environment of the power tool, wherein this air is guided as cooling air through the power tool in order to cool the constituent parts of the power tool that are intended to be protected from overheating. The consumed, i.e. in particular heated air is preferably discharged back into the environment through exhaust openings. In the present invention, the dust created when working with the power tool is blown by the air flowing out of the exhaust openings preferably into a spatial region in which the user of the power tool is not located. According to the invention, this region can be referred to as the “front region of the power tool”. In a preferred embodiment of the invention, an air curtain can form between the dust cloud that arises when the power tool is used and the user of the power tool, said air curtain acting as a shield for protecting the user from the dust. In this embodiment of the invention, it is preferred that the consumed air discharged through the exhaust openings forms an air curtain for protecting the user from dust.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

In the figures, identical and similar components are denoted by the same reference signs. In the figures:

FIG. 1 shows a schematic illustration of a preferred configuration of the invention

FIG. 2 shows a schematic illustration of a further preferred configuration of the invention

### DETAILED DESCRIPTION

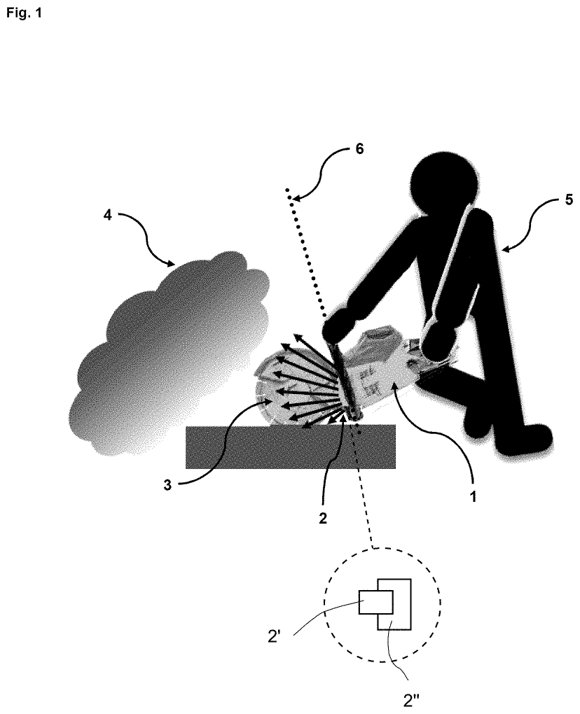

FIG. 1 shows a schematic illustration of a preferred configuration of the proposed power tool (1), which is being used by a user (5). FIG. 1 illustrates in particular how the user (5) machines a substrate with an angle grinder. The tool of the power tool (1) can be seen here, this being a cut-off disk in the exemplary embodiment, illustrated in FIG. 1, of the invention. The power tool (1) is subdivided into a front region and a rear region by a first handle. In the rear region of the power tool (1), a second handle can be arranged, which is preferably referred to as the rear handle of the power tool (1). When working with the power tool (1), the user (5) usually stands behind the power tool (1), i.e. in the spatial region that can be associated with the rear region of the power tool (1). This region can be referred to for short as the “rear region of the power tool (1)”.

When working with the power tool (1), dust (4) arises. This is the case in particular when abrasive substrates, for example concrete, are machined with the power tool (1). The dust (4) is illustrated schematically in FIG. 1 as a dust cloud; however, it can be distributed in any way in space. The power tool (1) has air cooling (not illustrated, arranged inside the power tool), wherein the power tool (1) discharges the air (3) consumed by the air cooling into the environment via exhaust openings (2). According to the invention, the term “consumed” means preferably that the air (3) has been guided through the power tool (1) in order to protect the components of the power tool (1) from possible overheating. The exhaust openings (2) can have various configurations. For example, they can be configured in a nozzle-like or movable manner. They are designed in particular to discharge the consumed air (3) into the environment such that the dust (4) that arises when working with the power tool (1) is blown away from the user (5) of the power tool (1). Since the user (5) usually stands behind the power tool (1) when working with it, the consumed air (3) is blown away from the power tool (1) preferably in a “forward” spatial direction. The consumed air (3) forms preferably an air flow that flows away from the power tool (1) into the environment of the power tool (1). The direction of flow of the consumed air (3) is illustrated in FIG. 1 by the arrows with the reference sign 3. The air flow formed by the consumed air (3) preferably entrains the dust (4) that arises when working with the power tool (1), such that it is transported away from the user (5) of the power tool (1). The position of the dust (4) blown away in this way is indicated in FIG. 1 by the dust cloud (4). The multiplicity of arrows 3 indicate that the power tool (1) has a plurality of exhaust openings (2). These can be arranged preferably in the region of the first handle of the power tool (1) and be oriented such that the consumed air (3), as indicated in FIG. 1, is blown away from the power tool (1) and the user (5). In particular, the arrows 3 define a “forward” spatial direction, while the user (5) defines a “rear” or “rearward” spatial direction with respect to the power tool (1).

The power tool (1) and the exhaust openings (2) can preferably also be designed so as to discharge the consumed air (3) out of the power tool (1) such than an air curtain (6) is formed from the consumed air. This air curtain (6) can be formed in a two-dimensional manner and form for example a plane. The plane defined by the air curtain (6) can be configured for example such that the first handle of the power tool (1) lies in this plane. Preferably, the air curtain (6) marks a boundary between a front region of the environment of the power tool (1), in which the dust (4) can propagate, and a rear region of the environment of the power tool (1). According to the invention, it is preferred that the user (5) of the power tool (1) is located in the rear region of the environment of the power tool (1), since the dust (4) of the power tool (1) is deliberately not blown into this region. Furthermore, the rear region of the environment of the power tool (1) is protected from the penetration of dust (4) by the air curtain (6). According to the invention, it is particularly preferred that the consumed air (3) is blown into a region of a tool of the power tool (1). The tool of the power tool (1) can be for example the cutting or cut-off disk of an angle grinder. This is associated with the advantage that the user (5) of the power tool (1), in particular while operating the power tool (1), is usually not located in the region of the tool of the power tool (1), since this may represent a hazardous region. Since the dust (4) is blown into a spatial region in which the user (5) is not located in practice while working with the power tool (1), the user (5) can be protected particularly effectively from the dust (4) and the adverse health effects associated with the dust (4). Preferably, the air flow formed by the consumed air (3) is fashioned by the configuration and number, arrangement and orientation of the exhaust openings (2) and blown in the desired direction. To this end, the power tool (1) can have suitable adjusting means (illustrated solely schematically in FIG. 1 as 2″ with a schematically shown nozzle 2′).

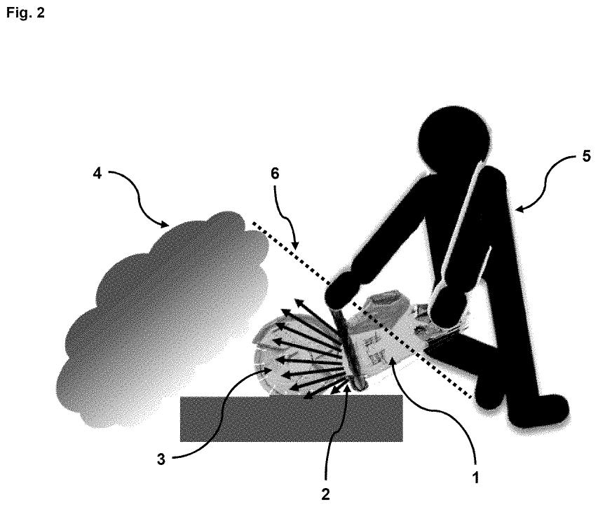

FIG. 2 shows a schematic illustration of a further preferred configuration of the proposed power tool (1). In the exemplary embodiment, illustrated in FIG. 2, of the power tool (1), the exhaust openings (2) are configured such that the air curtain (6) formed by the consumed air (3) of the power tool (1) is created at a different angle with respect to a surface to be machined. The air curtain (6) can for example be substantially perpendicular to the surface to be machined. In this case, the angle enclosed between the air curtain (6) and surface is about 90 degrees. However, the air curtain can also—as illustrated in FIG. 2—be inclined further forward. In this connection, the term “further forward” means that the air curtain (6) is inclined away from the user (5) of the power tool (1). The angle enclosed between the air curtain (6) and surface is then preferably less than 90 degrees. For example, such an inclination angle can be in a range from 20 to 90 degrees, preferably 30 to 60 degrees and particularly preferably between 35 and 45 degrees or between 70 and 80 degrees. Preferably, the air curtain (6) can adopt any inclination angle between 20 and 90 degrees.

### LIST OF REFERENCE SIGNS

1 Power tool
2 Exhaust openings
3 Consumed air
4 Dust
5 User
6 Air curtain

What is claimed is:

1-11. (canceled)

12. A power tool having air cooling for the components of the power tool, the power tool comprising:
exhaust openings for discharging consumed air to the environment of the power tool, the exhaust openings are configured such that dust arising during operation of the power tool is blown away from a user of the power tool.

13. The power tool as recited in claim 12 wherein the consumed air discharged through the exhaust openings forms an air curtain for protecting the user from dust.

14. The power tool as recited in claim 12 wherein the exhaust openings are variable in terms of position, design or direction, in order to blow the dust arising during operation of the power tool away from the user of the power tool.

15. The power tool as recited in claim 12 wherein the exhaust openings are variable in terms of position, design or direction, in order to form, from the consumed air of the air cooling, an air curtain for protecting the user from dust.

16. The power tool as recited in claim 12 wherein the exhaust openings are arranged in a region of a first handle of the power tool.

17. The power tool as recited in claim 12 wherein the consumed air is blown into a region of a tool of the power tool.

18. The power tool as recited in claim 12 wherein the exhaust openings include nozzles.

19. The power tool as recited in claim 18 wherein the nozzles are configured in a movable manner.

20. The power tool as recited in claim 12 further comprising and adjuster in order to set a flow rate or a volumetric flow within the consumed air discharged through the exhaust openings.

21. A method for protecting a user of a power tool from dust, the method comprising the following steps:
a) providing a power tool as recited in claim 12;
b) operating the power tool, the dust being created by the operation,
c) operating the air cooling of the power tool, with the result that an air flow is created within the power tool,
d) blowing the air consumed by the air cooling through the exhaust openings such that the dust arising during operation of the power tool is blown away from the user of the power tool.

22. The method as recited in claim 21 wherein the consumed air discharged through the exhaust openings forms an air curtain for protecting the user from dust.
